(19) United States
(12) Patent Application Publication
(10) Pub. No.: US 2014/0214860 A1
(43) Pub. Date: Jul. 31, 2014

(54) DATA GENERATION DEVICE, CONTENT REPRODUCTION DEVICE, AND STORAGE MEDIUM

(71) Applicant: SONY CORPORATION, TOKYO (JP)

(72) Inventors: YOICHIRO SAKO, Tokyo (JP); TAKATOSHI NAKAMURA, Tokyo (JP); MITSURU TAKEHARA, Tokyo (JP); ITARU KAWAKAMI, Kanagawa (JP); KAZUNORI HAYASHI, Tokyo (JP); TAKAYASU KON, Tokyo (JP); YASUNORI KAMADA, Kanagawa (JP); KOHEI ASADA, Kanagawa (JP); KAZUYUKI SAKODA, Chiba (JP); KAZUHIRO WATANABE, Tokyo (JP); HIROYUKI HANAYA, Kanagawa (JP); YUKI KOGA, Tokyo (JP); TOMOYA ONUMA, Shizuoka (JP); AKIRA TANGE, Tokyo (JP)

(73) Assignee: SONY CORPORATION, TOKYO (JP)

(21) Appl. No.: 14/153,242

(22) Filed: Jan. 13, 2014

(30) Foreign Application Priority Data
Jan. 25, 2013 (JP) 2013-012107

(51) Int. Cl. G06F 17/30

(52) U.S. Cl. CPC G06F 17/3053
USPC 707/748; 707/736

(57) ABSTRACT

There is provided a data generation device including a content specifying unit configured to specify content, a period estimation unit configured to estimate a period in which the content specified by the content specifying unit attracts interest, and a metadata generation unit configured to associate as metadata the period estimated by the period estimation unit with the content.

### CROSS REFERENCE TO RELATED APPLICATIONS

This application claims the benefit of Japanese Priority Patent Application JP 2013-012107 filed Jan. 25, 2013, the entire contents of which are incorporated herein by reference.

### BACKGROUND

The present disclosure relates to a data generation device, a content reproduction device, and a storage medium.

In recent years, a variety of content such as music, films, photos, and news articles in an electronic form has been generated in a large volume. To handle such a large volume of content, JP 2007-11928A discloses a content provision system configured to search for a certain content piece among content pieces including temporal information as metadata and configured to transmit the content piece acquired by the searching to a terminal, the searching being performed based on temporal information and information accompanying the temporal information included in a content acquisition request.

In addition, JP 2003-348559A discloses a technology of providing architecture which supports media content descriptions handling a variety of metadata including temporal information.

Moreover, JP 2006-235905A discloses a technology of generating, from a plurality of images, images in slide show format including BGM (Background Music) matching the content of the slide show and preferences of a user.

### SUMMARY

However, any of JP 2007-11928A, JP 2003-348559A, and JP 2006-235905A described above does not refer to associating temporal information with a certain content piece, the temporal information indicating a period in which people in general are interested in the content piece (a period in which the content piece is popular).

For example, JP 2007-11928A mentioned above describes using, as an attribute of temporal information, a release date or screen dates and times of a content piece such as a film or music. In addition, JP 2003-348559A mentioned above describes inclusion of data as temporal information in metadata, the data indicating the date and time of receiving the data or a year of portrayal in media content.

In contrast, JP 2006-235905A mentioned above describes generating as a BGM list including hit tunes in a certain period for a slide show based on the charts ranking described in the header of tune data. However, JP 2006-235905A does not describe a method for acquiring a popular period of other content than the tune data, a method for estimating a period during which an individual is interested in the content, and the like.

In light of the foregoing, it is desirable to provide a data generation device, a content reproduction device, and a storage medium, which are novel and improved, and which can provide content for recollecting particular times or bringing back memories based on a period in which the content attracts interest.

According to an embodiment of the present disclosure, there is provided a data generation device including a content specifying unit configured to specify content, a period estimation unit configured to estimate a period in which the content specified by the content specifying unit attracts interest, and a metadata generation unit configured to associate as metadata the period estimated by the period estimation unit with the content.

According to an embodiment of the present disclosure, there is provided a content reproduction device including a content specifying unit configured to specify a piece of first content, a period specifying unit configured to specify a period relevant to the piece of first content, a content extraction unit configured to extract, among pieces of second content associated with periods in which the respective pieces of second content attract interest, a piece of second content associated with a period overlapping with the period specified by the period specifying unit, and a content reproduction unit configured to reproduce the piece of second content extracted by the content extraction unit.

According to an embodiment of the present disclosure, there is provided a non-transitory computer-readable storage medium having a program stored therein, the program causing a computer to function as a content specifying unit configured to specify content, a period estimation unit configured to estimate a period in which the content specified by the content specifying unit attracts interest, and a metadata generation unit configured to associate as metadata the period estimated by the period estimation unit with the content.

According to an embodiment of the present disclosure, there is provided a non-transitory computer-readable storage medium having a program stored therein, the program causing a computer to function as a content specifying unit configured to specify a piece of first content, a period specifying unit configured to specify a period relevant to the piece of first content, a content extraction unit configured to extract, among pieces of second content associated with periods in which the respective pieces of second content attract interest, a piece of second content associated with a period overlapping with the period specified by the period specifying unit, and a content reproduction unit configured to reproduce the piece of second content extracted by the content extraction unit.

According to the embodiments of the present disclosure described above, it is possible to provide content for recollecting particular times or bringing back memories based on a period in which the content attracts interest.

### BRIEF DESCRIPTION OF THE DRAWINGS

FIG. 1 is a diagram for explaining an outline of a content provision system according to an embodiment of the present disclosure;

FIG. 2 is a diagram illustrating an example of an overall configuration of the content provision system according to a first embodiment;

FIG. 3 is a block diagram illustrating an example of an internal configuration of a smartphone according to the first embodiment;

FIG. 4 is a block diagram illustrating an internal configuration example of a data generation server according to the first embodiment;

FIG. 5 is a flowchart illustrating operation processing of metadata generation according to the first embodiment;

FIG. 6 is a flowchart illustrating first operation processing of reproduction control according to the first embodiment;

FIG. 7 is a flowchart illustrating second operation processing of the reproduction control according to the first embodiment;

FIG. 8 is a diagram for explaining an example of virtual space provision according to the first embodiment;

FIG. 9 is a diagram for explaining an outline of content provision according to a second embodiment; and

FIG. 10 is a block diagram illustrating an example of an internal configuration of a smartphone according to the second embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The descriptions will be given in the following order.

1. Outline of Content Provision System According to An Embodiment of Present Disclosure

2. Embodiments
2-1. First Embodiment
2-1-1. Internal Configuration Example of Smartphone
2-1-2. Internal Configuration Example of Data Generation Server
2-1-3. Operation Processing
2-1-4. Supplementary Explanation
2-2. Second Embodiment
2-2-1. Outline of Content Provision
2-2-2. Internal Configuration Example of Smartphone

3. Conclusion

<<1. Outline of Content Provision System According to An Embodiment of Present Disclosure>>

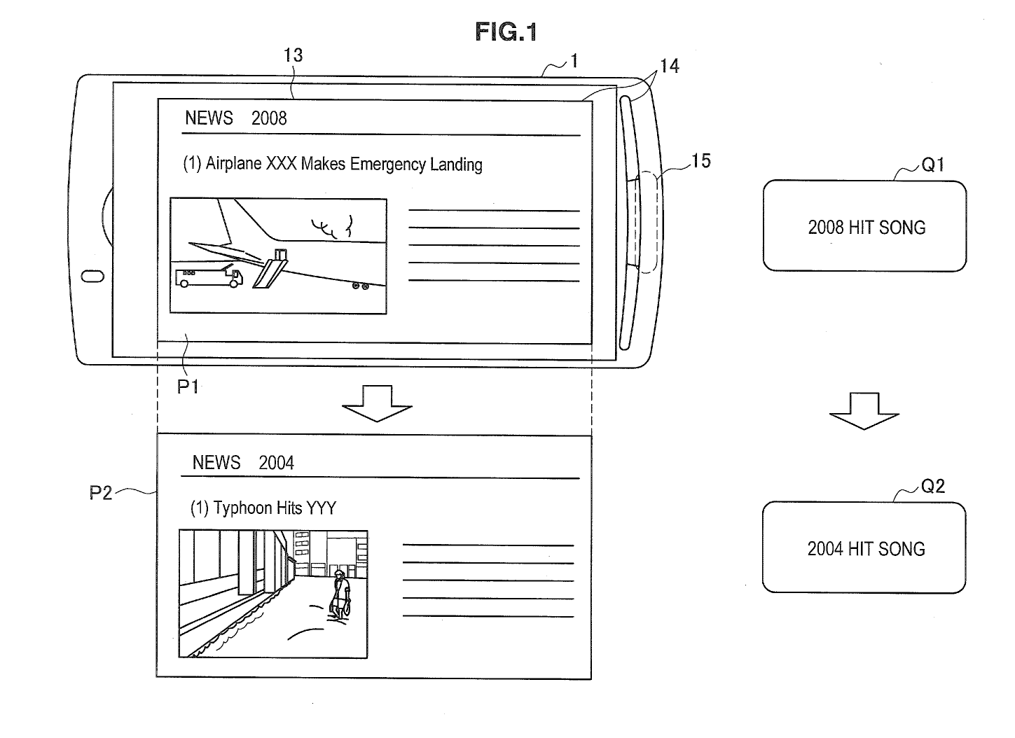

Firstly, an outline of a content provision system according to an embodiment of the present disclosure will be described with reference to FIG. 1.

FIG. 1 is a diagram for explaining the outline of the content provision system according to an embodiment of the present disclosure. As illustrated in FIG. 1, a smartphone 1 according to the present embodiment includes a display unit 13, a manipulation input unit 14, and a speaker 15 which is provided on a surface opposite from a surface on which the display unit 13 is provided. The manipulation input unit 14 may be a touch panel which is provided integrally with the display unit 13 as illustrated in FIG. 1 and which is configured to detect manipulation input to a display screen. The manipulation input unit 14 may also be a physical button provided separately from the display unit 13.

The display unit 13 displays a variety of content such as a photo, a film, a news article, and the like, in accordance with manipulation of a user. Here, suppose a case where when the user views a photo, a film, a news article, or the like having been provided in older days, the user listens to music which has been popular in a period when the photo has been taken, the film has been released, the news article has been carried, or the like. In such a case, memories in the period are brought back, and thus presence or longing tends to be enhanced.

For example, as of 2013, the user views a screen P1 displaying a 2008 news article by using the smartphone 1, and the smartphone 1 reproduces a 2008 hit song Q1 from the speaker 15. This brings back memories in those days in 2008 and exerts an advantageous effect of enhancing presence and longing. In addition, the user views a screen P2 displaying a 2004 news article in older days, and the smartphone 1 reproduces a 2004 hit song Q2 with the speaker 15. This likewise brings back memories in those days in 2004 and exerts the advantageous effect of enhancing presence and longing.

In addition, content which can bring back memories in those days and enhance presence and longing is not limited to music described above. For example, memories in those days can be brought back from video or literal content such as: an image of a fashion, a commodity, or a toy; a title of a game, a drama, a film, a novel, or a news article; a name of a play; a vogue word; or the like, each of which has been popular in those days.

Here, a popular period of a certain one of various content pieces, such as music, a film, a fashion, and a toy, is a period in which people in general or an individual is interested in the content piece after the content piece is generated. The popular period does not necessarily coincide with the release date or screen opening date of the content piece. In addition, in the case of a resold content piece, the date of resale of the content piece might considerably differ from the popular period thereof. Moreover, there is also a case (revival boom) where a content piece popular in the past becomes popular again. Also in such a case, a period including the release date, the premiere date, or the like of the content piece considerably differs from the second popular period. Further, in a case where a user is personally interested and absorbed in a certain content piece in a certain period, the period might considerably differ from a period including the release date, the premiere date, the date of sale, or the like which is generally announced.

Information such as the release date, the premiere date, and the like of a content is determined by a content producer company, a content seller company, or the like, and is often provided to the content as metadata when the content is generated, thus being generally easy to obtain. However, a popular period of content is difficult to predict in advance, and thus is generally not provided to the content in advance. Accordingly, to provide content for recollecting particular times and bringing back memories, it is necessary to provide a mechanism for firstly providing a popular period of the content as metadata.

Hence, according to the present embodiment, a popular period of content (a period in which people in general or an individual is interested in the content) is estimated, and metadata indicating the estimated period is generated in association with the content. Thus, it is possible to provide content for recollecting particular times and bringing back memories.

Further, based on a period (such as a shooting date or a release date) relevant to first content viewed/listened/selected by the user, the smartphone 1 (content reproduction device) according to the present embodiment can extract and reproduce second content which has been popular in the period. At this time, the second content is extracted based on a popular period associated with the second content as metadata as described above. By viewing or listening to the reproduced second content, the user recollects the period relevant to the first content viewed/listened/selected and thus can feel presence and longing.

The outline of the content provision system according to an embodiment of the present disclosure has heretofore been described. Note that the smartphone 1 is used as an example of the content reproduction device in the present embodiment, but the content reproduction device according to an embodiment of the present disclosure is not limited to the smartphone 1. For example, the content reproduction device according to the present embodiment may be an information processing apparatus such as a tablet terminal, a mobile phone terminal, a PDA (Personal Digital Assistant), a PC (Personal Computer), a digital camera, a video camcorder, a game machine, an electronic book terminal, or the like. Subsequently, the content provision system according to an embodiment of the present disclosure will be specifically described by using first and second embodiments.

### 2. EMBODIMENTS

### 2-1. First Embodiment

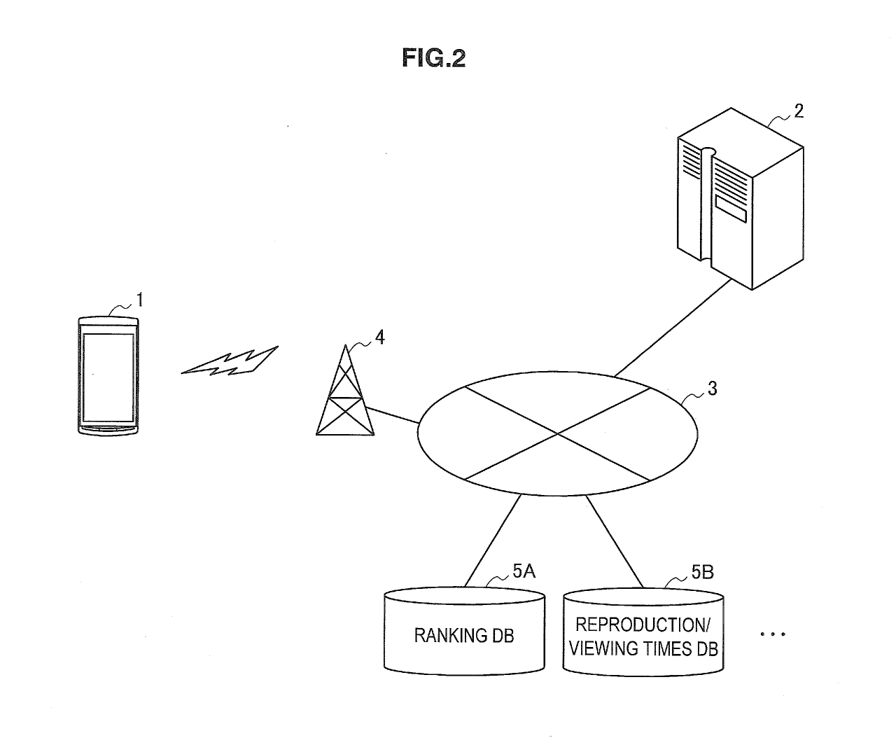

FIG. 2 is a diagram illustrating an overall configuration of the content provision system according to the first embodiment. As illustrated in FIG. 2, the content provision system according to the present embodiment includes the smartphone 1 (content reproduction device) and a data generation server 2.

The smartphone 1 is connected to a base station 4 in wireless communication, and transmits and receives data to and from the data generation server 2 through the base station 4 and a network 3. The smartphone 1 has a function of acquiring, from the data generation server 2, content which has been popular in a period relevant to first content viewed/listened/selected in the smartphone 1 and reproducing the content.

The data generation server 2 has functions of: estimating a period in which particular content has been popular; and generating metadata indicating the estimated period in association with the content. For example, the data generation server 2 can estimate a period in which the particular content has been popular based on data stored in a ranking DB (database) 5A on the network 3, a reproduction/viewing times DB 5B each of which is illustrated in FIG. 2, or the like. Moreover, the data generation server 2 may also estimate the popular period of the particular content based on information on accumulated hours of news broadcasting, information on a vogue word award, information on the number of times of placing fashions or commodities on magazines, news articles released from trend information companies, modern terms dictionary data edited with new words and vogue words added thereto, and the like. Further, the data generation server 2 may also estimate the popular period of the particular content based on: recording times information indicating the number of audio or image recording times or photo shooting times for the particular content; recording duration information indicating a recording duration taken for the audio or image recording or the photo shooting; or the like.

The ranking DB 5A is a storage unit which stores a variety of ranking information used in estimating a popular period of content. The variety of ranking information specifically means: the charts of music, films, books, and dramas; toy sales ranking information; important news ranking information; and the like. Here, the charts may be the charts on a major market or on minor markets such as independent label markets. The ranking information may be ranking information by gender, generation, or country. The ranking information may also be annual, monthly, weekly, or daily ranking information.

The reproduction/viewing times DB 5B is a storage unit which stores information on the numbers of reproduction/viewing times of music, films, books, drams, news articles, and the like which are provided on the network.

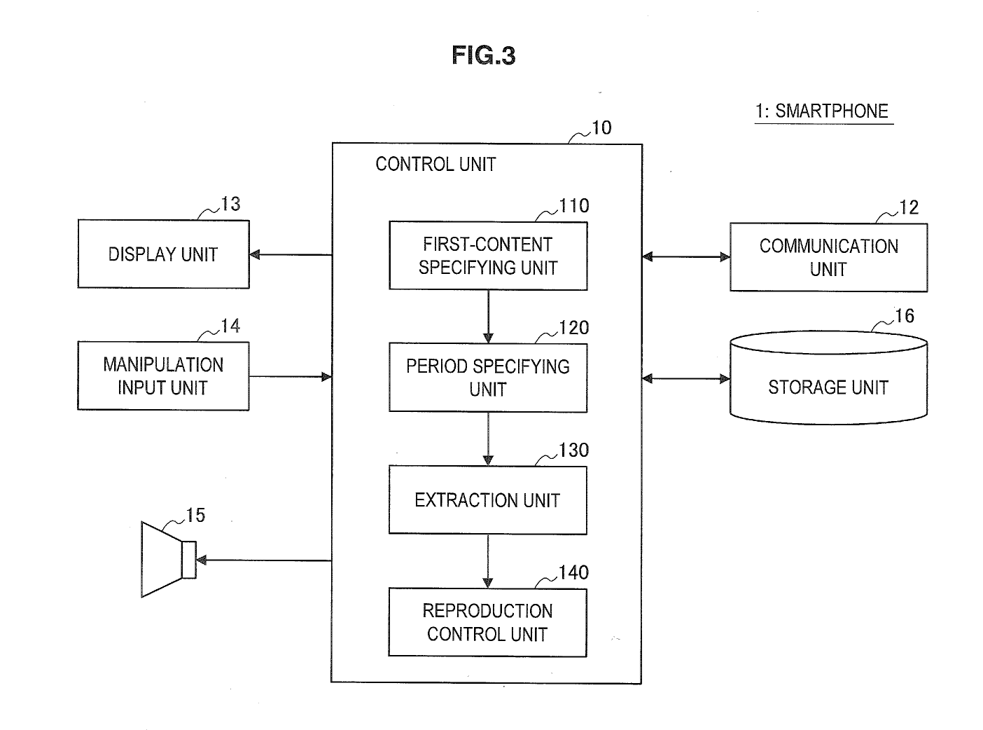

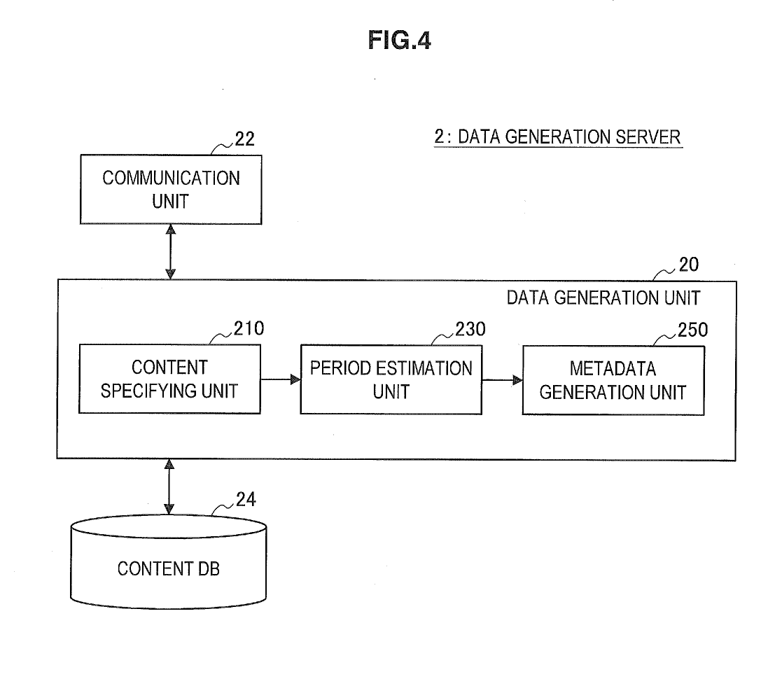

The overall configuration of the content provision system according to the first embodiment has heretofore been described. Next, internal configuration examples of the smartphone 1 and the data generation server 2, respectively, included in the content provision system according to the present embodiment will be described with reference to FIGS. 3 and 4 in order.

(2-1-1. Internal Configuration Example of Smartphone)

FIG. 3 is a block diagram illustrating the internal configuration example of the smartphone 1 according to the first embodiment. As illustrated in FIG. 3, the smartphone 1 according to the present embodiment includes a control unit 10, a communication unit 12, the display unit 13, the manipulation input unit 14, the speaker 15, and a storage unit 16.

(Control unit)

The control unit 10 issues instructions to the components of the smartphone 1 to control the entire smartphone 1. Specifically, as illustrated in FIG. 3, the control unit 10 functions as a first-content specifying unit 110, a period specifying unit 120, an extraction unit 130, and a reproduction control unit 140.

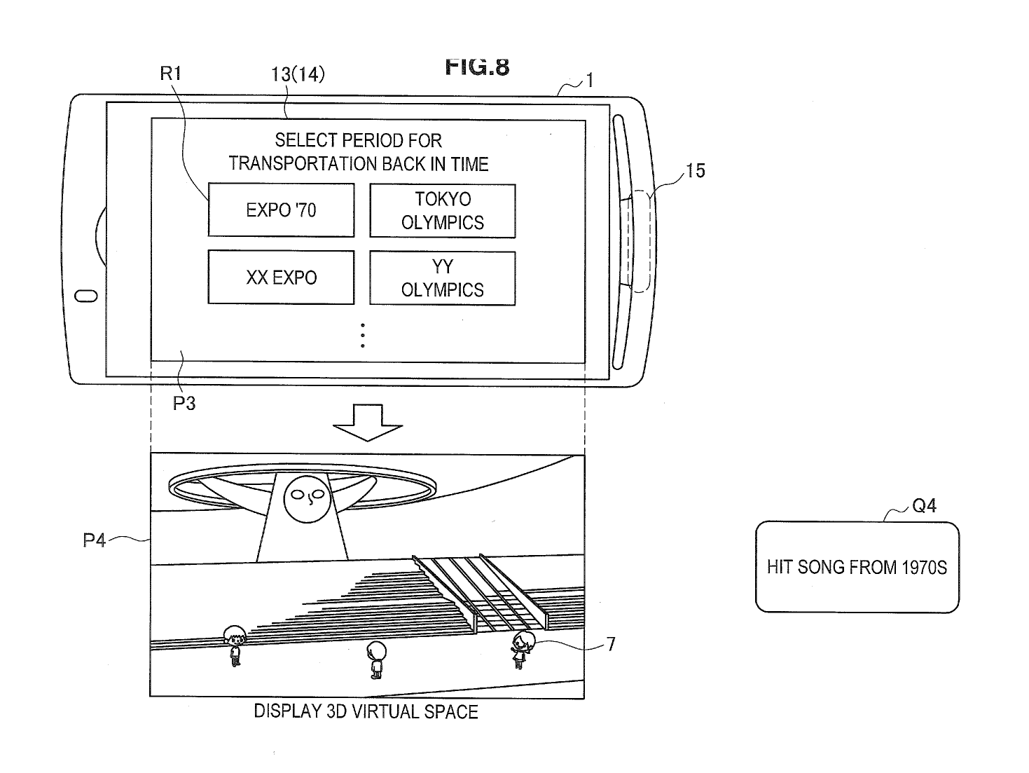

The first-content specifying unit 110 specifies first content designated by the user. Specifically, the first-content specifying unit 110 specifies content (for example, news articles P1 and P2 in FIG. 1) currently viewed or listened to by the user or content (for example, a selected item R1 in FIG. 8) selected by the user.

The period specifying unit 120 specifies a period relevant to the first content specified by the first-content specifying unit 110. The period relevant to the first content is, for example, a period in which the first content is acquired, publicized, or held. Specifically, the period relevant to the first content is: a shooting date in the case where the first content is photo data; a release date, music or book data; an air date, drama data; a premiere date, film data; a Web site posting date, news article data; and a holding date, an event. The period specifying unit 120 may specify the period relevant to the first content, by extracting the period from metadata which is associated with the first content when the first content is generated, or by acquiring the period from the network.

The extraction unit 130 extracts second content which has been popular in the period specified by the period specifying unit 120. The extraction unit 130 may acquire the second content from the data generation server 2 through the network 3, or from the storage unit 16. The storage unit 16 stores in advance second content associated with metadata generated by the data generation server 2. The extraction unit 130 extracts second content associated as the metadata with a popular period overlapping with the period specified by the period specifying unit 120.

The reproduction control unit 140 controls reproduction of the second content extracted by the extraction unit 130. Specifically, when the second content is image/text data, the reproduction control unit 140 controls the reproduction thereof in a manner that the display unit 13 performs display reproduction of the second content. When the second content is audio data, the reproduction control unit 140 controls the reproduction of the second content in a manner that the speaker 15 performs audio reproduction.

In addition, the reproduction control unit 140 may control reproduction in a manner that the first content and the second content are reproduced. For example, the reproduction control unit 140 may not only display a news article which is the first content on the display unit 13 but also output music which is the second content from the speaker 15. The reproduction control unit 140 may also display a photo which is the first content and the second content which has been popular at the time of shooting the photo together with the first content on the display unit 13, the second content including: an image of a fashion, a commodity, a toy, or the like; and a title of a game, a drama, a film, or the like. When the user views or listens to the second content which has been popular in the period of first content acquisition or the like, this brings back memories in those days and enhances presence and longing.

Further, when the extraction unit 130 extracts a plurality of second content pieces, the reproduction control unit 140 may reproduce the second content pieces in order according to the degree of popularity or in a random order. For example, the reproduction control unit 140 may control the reproduction of music in the charts in a particular generation from the top in order.

(Communication Unit)

The communication unit 12 is an interface for transmitting and receiving data to and from an external device. For example, the communication unit 12 transmits and receives data by using a wireless LAN (Local Area Network), infrared rays, Wi-Fi (registered trademark), Bluetooth (registered trademark), or the like. The communication unit 12 according to the present embodiment is connected to the base station 4 in wireless communication and can transmit and receive data to and from the data generation server 2 further through the network 3.

(Display Unit)

The display unit 13 displays various screens such as a manipulation screen and a menu screen. The display unit 13 according to the present embodiment also performs display reproduction of content such as an image (a photo or video) or text under control of the reproduction control unit 140.

(Manipulation Input Unit)

The manipulation input unit 14 has a function of detecting manipulation input by the user. As illustrated in FIG. 1, the manipulation input unit 14 may be a touch panel which is integrated into the display unit 13 and which is configured to detect touch manipulation of a screen, or may be a physically formed button.

(Speaker)

The speaker 15 is an audio output unit configured to output audio signals and may have an amplification circuit. The speaker 15 according to the present embodiment reproduces predetermined audio signals under control of the reproduction control unit 140.

(Storage Unit)

The storage unit 16 stores therein various programs provided for the control unit 10 to execute functions of the control unit 10 and various data files. The storage unit 16 according to the present embodiment may also store therein first content and second content.

The internal configuration example of the smartphone 1 according to the first embodiment has heretofore been described in detail with reference to FIG. 3.

(2-1-2. Internal Configuration Example of Data Generation Server)

As described above, the extraction unit 130 of the smartphone 1 extracts second content which has been popular in a period specified by the period specifying unit 120, based on a popular period having been associated as the metadata with the second content. According to the present embodiment, the data generation server 2 beforehand performs processing of associating such a popular period as the metadata with the second content. Hereinafter, a configuration of the data generation server 2 according to the present embodiment as described above will be described in detail with reference to FIG. 4.

FIG. 4 is a block diagram illustrating an internal configuration example of the data generation server 2 according to the first embodiment. As illustrated in FIG. 4, the data generation server 2 according to the present embodiment includes a data generation unit 20, a communication unit 22, and a content DB 24.

(Data Generation Unit)

The data generation unit 20 generates metadata in association with particular content (second content), the metadata indicating a period in which the content has been popular. Specifically, the data generation unit 20 functions as a content specifying unit 210, a period estimation unit 230, and a metadata generation unit 250 as illustrated in FIG. 4.

The content specifying unit 210 specifies content (second content) for which metadata indicating a popular period is to be generated. The content specifying unit 210 may serially specify content pieces stored in the content DB 24, may specify a content piece according to a command from another device, or may continuously and randomly specify a variety of content pieces existing on the network.

The period estimation unit 230 estimates a popular period of the content specified by the content specifying unit 210. Note that a popular period of content herein means a period in which the content attracts interest. In a case where the content is news, the popular period is also referred to as an attention period. The popular period of the content is estimated based on ranking information, information on the number of reproduction/viewing times, or the like. The period estimation unit 230 estimates a popular or attention period of content such as a tune, video, a game, news, play, a toy, a vogue word, a commodity, or a fashion.

Specifically, based on the charts of tunes, video, and games stored in the ranking DB 5A, the period estimation unit 230 may obtain a period in which the tune, the video, or the game reaches the first place or predetermined place or higher in the predetermined charts, as an estimation result of a popular period thereof. When a tune, a video, a game, or the like is stored in a cloud computing system, the period estimation unit 230 may obtain, as an estimation result of a popular period thereof, a period exhibiting the number of reproduction/viewing times which is equal to or larger than a predetermined value and is the largest, based on the information on the number of reproduction/viewing times stored in the reproduction/viewing times DB 5B. When the number of reproduction/viewing times is smaller than the predetermined value, the period estimation unit 230 may consider that the popular period does not exist and then terminate the metadata generation. Note that the period estimation unit 230 can also estimate a popular period of music or video based on recording times information indicating the number of audio or image recording times or recording duration information indicating a recording duration taken for the audio or image recording.

The period estimation unit 230 may also obtain, as an estimation result of an attention period of a news item, a period in which the news item reaches the first place or predetermined place or higher, based on important news ranking information stored in the ranking DB 5A. When a news item is posted on a web site, the period estimation unit 230 may obtain, as an estimation result of an attention period of the news item, a period exhibiting the number of viewing times which is equal to or larger than a predetermined value and is the largest, based on the viewing times information stored in the reproduction/viewing times DB 5B. When the number of viewing times is smaller than the predetermined value, the period estimation unit 230 may consider that the popular period does not exist and then terminate the metadata generation. When a news item is broadcasted, the period estimation unit 230 may obtain, as an estimation result of an attention period of the news item, a period exhibiting a value of a broadcasting duration of the news item which is equal to or larger than a predetermined value and is the largest, based on broadcasting duration information. Further, the period estimation unit 230 may obtain, as an estimation result of an attention period of the news item, a period exhibiting the number of social bookmarks of the news item which is equal to or larger than a predetermined value and is the largest.

Based on: modern terms dictionary data; a graph indicating changes of the number of searching times of a particular keyword in Web search with the elapse of time; or the like, the period estimation unit 230 may also obtain, as an estimation result of a popular period of children's play, a year when the play has been placed in the modern terms dictionary for the first time or a year which exhibits the largest number of searching times.

Based on sales ranking information stored in the ranking DB 5A, the period estimation unit 230 may also obtain, as an estimation result of a popular period of a toy, a period in which the toy reaches the first place or predetermined place or higher.

Based on data of the vogue word awards in respective past years, the period estimation unit 230 may also obtain, as an estimation result of a popular period of a vogue word, a year when the vogue word is nominated. The period estimation unit 230 may also estimate a popular period of a vogue word based on a graph indicating changes of the number of searching times of a particular keyword in Web search with the elapse of time or based on the modern terms dictionary.

The period estimation unit 230 may also obtain, as an estimation result of a popular period of a commodity, a date when popularity of the commodity is introduced in a broadcast program or when the commodity is placed in a news article. Moreover, based on the sales ranking information stored in the ranking DB 5A, the period estimation unit 230 may also obtain, as an estimation result of a popular period of a commodity, a period in which the commodity reaches the first place or predetermined place or higher.

The period estimation unit 230 may also estimate a popular period of a fashion based on: information on the number of magazine placement times; modern terms dictionary data; news articles released from fashion trend information companies; and the like. For example, based on the information on the number of magazine placement times, the period estimation unit 230 may obtain, as an estimation result of a popular period of a certain fashion, a year when the fashion has been placed most frequently on magazines, or a year when a term meaning the fashion has been placed in the modern terms dictionary data for the first time. Meanwhile, the direction of a fashion trend is decided in advance in a predetermined process by the fashion industry (for example, determining the direction of a fashionable color about two years earlier, the direction of a trend about one year and a half earlier, the direction of a material about one year earlier, and the like). Thus, the period estimation unit 230 may estimate a popular period by calculations based on news articles released from fashion trend information companies. Note that the period estimation unit 230 can estimate a popular period of a fashion based on the recording times information indicating the number of times of shooting the fashion.

The specific methods for estimating a popular period by the period estimation unit 230 have heretofore been described. Note that the period estimation unit 230 may weight the estimated popular period, based on the type of data used for the estimation (the ranking information, the information on the number of reproduction/viewing times, the modern terms dictionary data, or the like), data reliability, or the like.

The metadata generation unit 250 performs processing of associating, as metadata, a popular period estimated by the period estimation unit 230 with specified content (second content). At this time, the metadata generation unit 250 may associate, as metadata, not only the popular period but also the rank or the like used as a basis of the estimation. The metadata generation unit 250 also stores the content associated with the popular period as the metadata, in the content DB 24.

(Communication Unit)

The communication unit 22 is an interface for transmitting and receiving data to and from external devices. The communication unit 22 according to the present embodiment can transmit and receive data to and from the smartphone 1, the ranking DB 5A, and the reproduction/viewing times DB 5B, through the network 3.

(Content DB)

The content DB 24 is a database configured to at least store a variety of content pieces associated with estimated popular periods as the metadata. Note that the content DB 24 is included in the data generation server 2 in the configuration illustrated in FIG. 4, but the configuration of the embodiment of the present disclosure is not limited thereto. The content DB 24 may be an external storage unit.

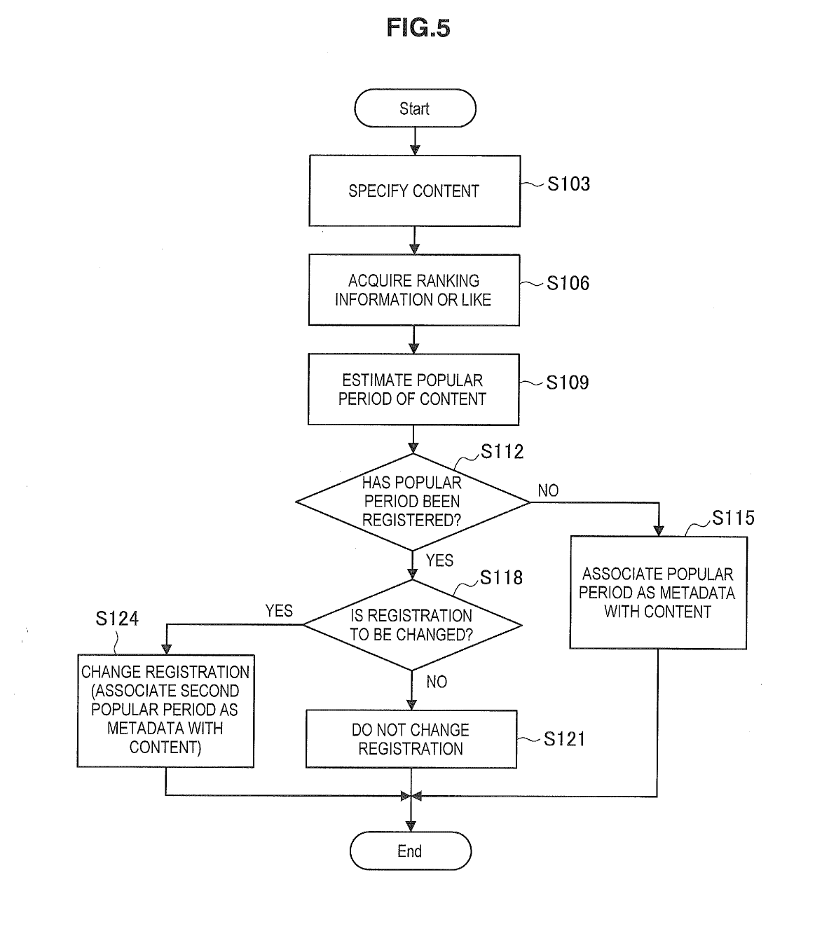

The internal configuration example of the data generation server 2 according to the present embodiment has heretofore been described in detail. Subsequently, operation processing of the content provision system according to the present embodiment will be described specifically with reference to FIGS. 5 to 7.

(2-1-3. Operation Processing)

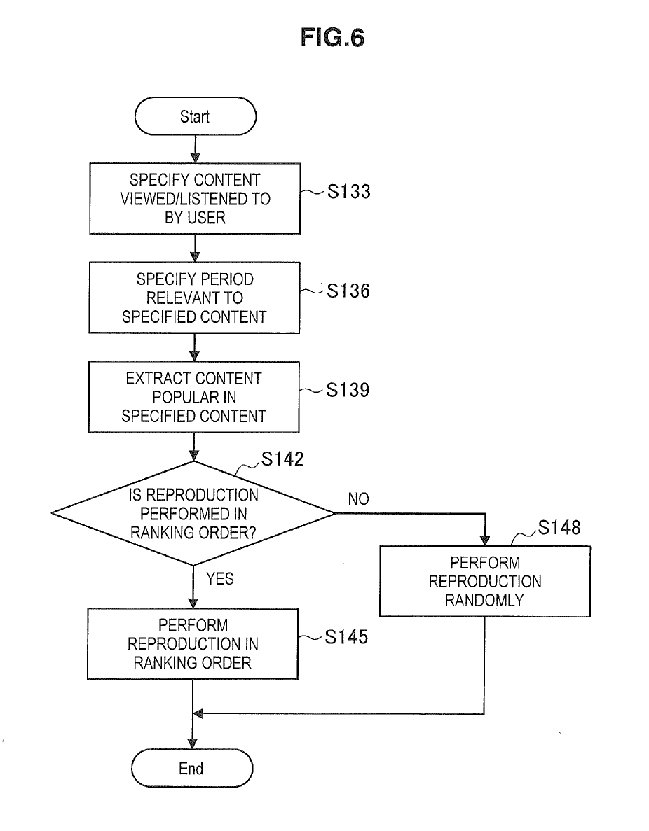

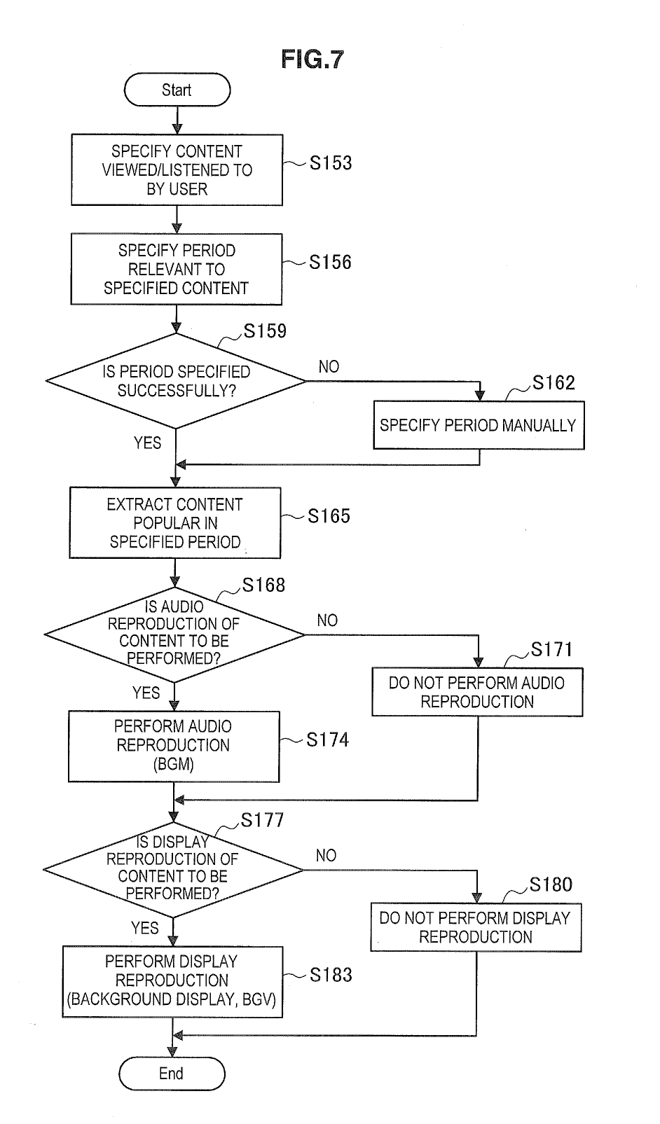

In the content provision system according to the present embodiment, the data generation server 2 performs processing of associating a popular period with content (metadata generation processing), and the smartphone 1 controls reproduction of second content which has been popular in a period relevant to first content. Hereinafter, the metadata generation processing performed by the data generation server 2 will be described with reference to FIG. 5, and reproduction control processing for the second content performed by the smartphone 1 will be described with reference to FIGS. 6 and 7.

(Metadata Generation Processing)

FIG. 5 is a flowchart illustrating the operation processing of the metadata generation according to the first embodiment. As illustrated in FIG. 5, firstly in Step S103, the content specifying unit 210 of the data generation server 2 specifies content on which popular-period estimation processing is to be performed.

Next, in Step S106, the period estimation unit 230 acquires ranking information or the like as information for estimating a popular period of the specified content.

Next, in Step S109, the period estimation unit 230 estimates the popular period of the content based on the acquired information.

Subsequently, in Step S112, the metadata generation unit 250 determines whether or not a popular period has been registered for the content (has been associated as metadata with the content).

Next, when the popular period has not been registered yet (No in S112), the metadata generation unit 250 generates metadata which is the estimated popular period in association with the content in Step S115.

On the other hand, when the popular period has already been registered (Yes in S112), the metadata generation unit 250 determines in Step S118 whether or not to change the registration. Whether or not to change the registration may be determined according to change availability which has been set in advance.

When the registration is not to be changed (No in S118), the metadata generation unit 250 does not change the registration in Step S121, and the metadata generation processing is terminated.

When the registration is to be changed (Yes in S118), the metadata generation unit 250 changes the registration in Step S124 in a manner that the estimated popular period is added to the metadata as a second popular period. The second popular period is used in a case where the content has a plurality of popular periods. For example, occurrence of a revival boom of the content is applicable to this case. When there is a third or fourth popular period, the metadata generation unit 250 can add a popular period in the same manner by performing the registration change processing. Note that when a wrong popular period has been registered, or when a more accurate popular period is successfully obtained, the metadata generation unit 250 does not additionally register a new popular period but changes the registration in such a manner as to overwrite the popular period (erase the original popular period and write a new popular period).

The metadata generation processing performed by the data generation server 2 according to the present embodiment has heretofore been described. The aforementioned processing may be performed in a manner that content pieces are continuously and serially specified.

(Reproduction Control Processing)

Next, a description is given of the reproduction control processing according to the present embodiment. As described above, the smartphone 1 according to the present embodiment controls reproduction of second content which has been popular in a period relevant to first content. Here, a case where there are a plurality of second content pieces which are the same type of data will be described with reference to FIG. 6, and a case where there are a plurality of second content pieces which are different types of data will be described with reference to FIG. 7.

FIG. 6 is a flowchart illustrating first operation processing in the reproduction control according to the first embodiment. As illustrated in FIG. 6, firstly in Step S133, the first-content specifying unit 110 of the smartphone 1 specifies content (first content) viewed or listened to by the user. The content viewed or listened to by the user means, for example, content displayed on the display unit 13 or content for which audio is outputted from the speaker 15.

Next, in Step S136 the period specifying unit 120 specifies a period relevant to the specified content. For example, the period specifying unit 120 specifies a period in which a news article viewed or listened to by the user is carried (in an example in FIG. 1, a period relevant to the news article P1 is 2008, and the period relevant to the news article P2 is 2004).

Next, in Step S139, the extraction unit 130 extracts content which have been popular in the period specified by the period specifying unit 120. For example, among the second content pieces associated as metadata with popular periods of the second content pieces, the extraction unit 130 extracts at least one second content piece associated with a period overlapping with the specified period, from the content DB 24 of the data generation server 2. In the example in FIG. 1, the extraction unit 130 extracts: the 2008 hit song Q1 in the case where the specified period is 2008; or the 2004 hit song Q2 in the case where the specified period is 2004.

Subsequently, the reproduction control unit 140 controls reproduction of the second content extracted by the extraction unit 130 in a manner that the second content is reproduced on the display unit 13 or through the speaker 15. By viewing or listening to the second content, the user recollects the period relevant to the first content viewed or listened to and thus feels presence and longing. For example, when viewing the news article P1 in the example in FIG. 1, the user listens to the hit song Q1. The user recollects 2008 which is a period in which the news article P1 has been carried, and feels presence and longing.

Here, when a plurality of second content pieces are extracted, the reproduction control unit 140 controls the reproduction in such a manner as to reproduce the second content pieces in order. Specifically, in Step S142, the reproduction control unit 140 determines whether or not to reproduce the second content pieces in the ranking order. Whether or not to reproduce the second content pieces may be determined according to setting made in advance.

Next, when it is determined that the reproduction is to be performed in the ranking order (Yes in S142), in Step S145 the reproduction control unit 140 reproduces the second content pieces in the ranking order from the top. For example, when a plurality of music pieces associated with a popular period of 2008 are extracted, the reproduction control unit 140 controls the reproduction according to the charts ranking associated together with the popular period or the charts ranking in 2008 separately acquired.

On the other hand, when it is determined that the reproduction is not to be performed in the ranking order (No in S142), in Step S148 the reproduction control unit 140 controls the reproduction in such a manner as to randomly reproduce the plurality of second content pieces.

The reproduction control processing performed by the smartphone 1 has heretofore been described. In the example in FIG. 6, when being the same type of data, for example, being audio data, the plurality of extracted second content pieces can be reproduced in order through the speaker 15 by the reproduction control unit 140. Here, when being different types of data, for example, being image/text data and audio data, the plurality of extracted second content pieces can be reproduced on the display unit 13 and through the speaker 15 by the reproduction control unit 140. Hereinafter, a specific description is given with reference to FIG. 7.

FIG. 7 is a flowchart illustrating second operation processing in the reproduction control according to the first embodiment. As illustrated in FIG. 7, firstly in Step S153, the first-content specifying unit 110 of the smartphone 1 according to the present embodiment specifies content (first content) viewed and listened to by the user.

Next, in Step S156, the period specifying unit 120 specifies a period relevant to the specified content (first content).

When the period has not been specified successfully (No in S159), in Step S162 the period specifying unit 120 specifies a period manually inputted by the user as the period relevant to the first content.

Subsequently, in Step S165, the extraction unit 130 extracts at least one second content piece which has been popular in the specified period.

Next, in Step S168, the reproduction control unit 140 determines whether or not to perform the audio reproduction on the extracted second content piece. For example, when a plurality of second content pieces are extracted and include an audio-reproducible content piece (audio data), the reproduction control unit 140 determines that the audio reproduction is to be performed. In a case where the second content pieces include an audio-reproducible content piece but where the audio reproduction is being performed on the first content through the speaker 15, the reproduction control unit 140 may determine that the audio reproduction is not to be performed.

Next, when it is determined that the audio reproduction is not to be performed (No in S168), in Step S171 the reproduction control unit 140 does not perform the audio reproduction on the second content pieces.

On the other hand, when it is determined that the audio reproduction is to be performed (Yes in S168), in Step S174 the reproduction control unit 140 controls the reproduction of the second content pieces in such a manner as to perform the audio reproduction of the corresponding second content piece through the speaker 15. For example, as illustrated in FIG. 1, when the user views the news article P1 on the display unit 13, reproducing the 2008 hit song Q1 as BGM through the speaker 15 brings back memories in 2008 which is a period in which the news article P1 has been carried.

Next, in Step S177, the reproduction control unit 140 determines whether or not to perform the display reproduction of the corresponding extracted second content piece. For example, when a plurality of second content pieces are extracted and include a display-reproducible content piece (image/text data), the reproduction control unit 140 determines that the display reproduction is to be performed. When the extracted second content pieces do not include a display-reproducible content piece, the reproduction control unit 140 determines that the display reproduction is not to be performed.

When it is determined that the display reproduction is not to be performed (No in S177), the reproduction control unit 140 does not perform the display reproduction of the second content pieces in Step S180.

On the other hand, it is determined that the display reproduction is to be performed (Yes in S177), in Step S183 the reproduction control unit 140 controls reproduction of the second content pieces in a manner that the display unit 13 performs the display reproduction of the corresponding second content piece. For example, the user listens to old music (first content) reproduced through the speaker 15. Then, when an image of a fashion or play which has been popular in the release year of the music is displayed as BGV (Background Video) on the display unit 13, this brings back memories of those days and enhances the presence. In a case where the display unit 13 is performing the display reproduction of the first content, the reproduction control unit 140 may display the second content in a manner that the second content is superimposed on the first content, placed by the first content, or displayed on the background.

As described above, when different types of the plurality of second content pieces are extracted, reproduction can be controlled to be performed both on the display unit 13 and through the speaker 15 (S174 and S183). This provides an advantageous effect of bringing back memories of the period relevant to the first content more easily and enhancing presence and longing. Subsequently, a description is given of supplementary explanation to the content provision system according to the present embodiment.

(2-1-4. Supplementary Explanation)

Specifying content by the first-content specifying unit 110 according to the present embodiment is not limited to the example in which content viewed and listened to by the user is specified as first content. For example, an item selected by the user may be specified as first content. In addition, the reproduction control unit 140 according to the present embodiment may generate a 3D virtual space based on one or more extracted second content pieces to perform display reproduction. Hereinafter, a specific description is given with reference to FIG. 8.

FIG. 8 is a diagram for explaining an example of virtual space provision according to the first embodiment. As illustrated in FIG. 8, the display unit 13 of the smartphone 1 displays a selection screen P3. The selection screen P3 includes items showing names of events held in the past such as “EXPO '70” and “Tokyo Olympics”.

The user touches and selects one of items displayed in the selection screen P3 which indicates a period to which the user wishes to be transported back in time. In this case, the first-content specifying unit 110 specifies the selected item as first content, based on the user's manipulation input detected by the manipulation input unit 14.

For example, when an item R1 which is “EXPO '70” is selected, the first-content specifying unit 110 specifies “EXPO '70” as first content. Next, the period specifying unit 120 specifies a period in which EXPO '70 has been held (specifically, 1970) as a period relevant to “EXPO '70”. Then, as second content pieces having been popular in the period in which EXPO '70 has been held, the extraction unit 130 extracts: 3D images of the site of EXPO '70; images of fashion, food, and the like in the 1970s; a hit song from the 1970s Q4; and the like.

Then, the reproduction control unit 140 generates a 3D virtual space P4 of times (the 1970s) when EXPO '70 has been held as illustrated in FIG. 8, based on the extracted second content pieces and performs reproduction display of the 3D virtual space P4. This can bring back memories of those days and causes the user to feel presence and longing.

In addition, in an example in FIG. 8, an avatar 7 of the user is displayed in the 3D virtual space P4, and thus the user can virtually experience the site of EXPO '70 by using the avatar 7.

Further, the reproduction control unit 140 not only performs the reproduction display of the 3D virtual space P4 but also reproduces the extracted 1970 hit song Q4 as BGM through the speaker 15. This can bring back memories of the user further and enhance presence and longing.

The first embodiment has heretofore been described in detail. Note that the configuration of the content provision system according to an embodiment of the present disclosure is not limited to the configuration illustrated in FIGS. 2 to 4. For example, the smartphone 1 may have the functions of the data generation server 2 to perform the metadata generation processing (popular-period association processing). Specifically, the control unit 10 of the smartphone 1 functions as not only the first-content specifying unit 110, the period specifying unit 120, the extraction unit 130, and the reproduction control unit 140 which are illustrated in FIG. 3 but also the content specifying unit 210, the period estimation unit 230, and the metadata generation unit 250 which are illustrated in FIG. 4. In this case, the content DB 24 in FIG. 4 is included in the storage unit 16 of the smartphone 1.

### 2-2. Second Embodiment

Next, a description is given of a second embodiment of the present disclosure. In the aforementioned first embodiment of the present disclosure, the period estimation unit 230 mainly obtains, as an estimation result of a popular period of particular content (second content), a period in which people in general are interested in the content. However, a period in which the user is interested in the content (a period in which the user is personally absorbed in the content) might differ from the popular period of the people in general, depending on the user.

In this case, it is assumed that there are differences among users in times recollected or memories brought back at the time of reproducing the second content extracted by the extraction unit 130.

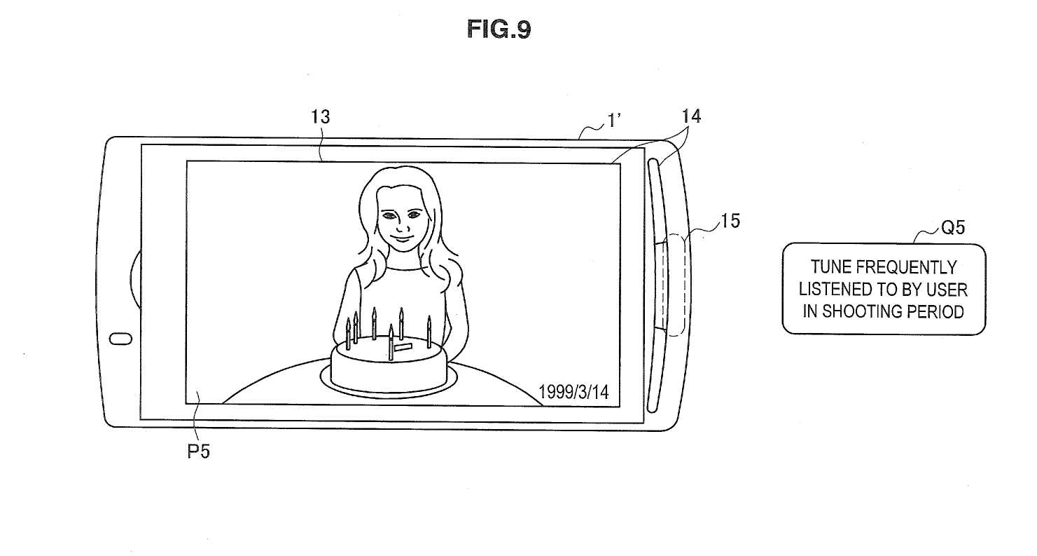

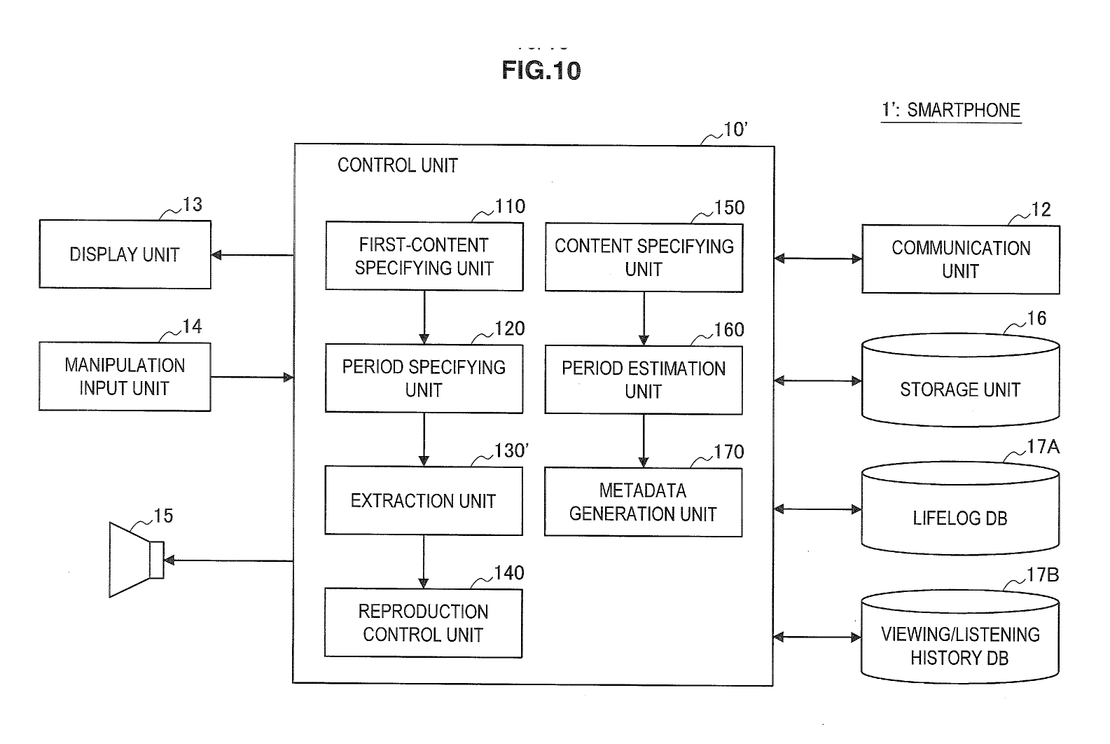

Hence, the second embodiment of the present disclosure specifically describes a case where a period in which an individual is interested in content (personalized popular period) is estimated and is associated with the content as the metadata. Hereinafter, the description is given with reference to FIGS. 9 and 10.

(2-2-1. Outline of Content Provision)

FIG. 9 is a diagram for explaining an outline of content provision according to the second embodiment. As illustrated in FIG. 9, when displaying, for example, a photo image P5 as first content on the display unit 13, a smartphone l′ according to the present embodiment extracts as second content a tune Q5 which a user personally has been interested in and has frequently listened to in a period when the photo image P5 has been taken. In the present embodiment, the second content is extracted based on not a popular period of people in general but a popular period personalized for the user, and thereby it is possible to extract content which can bring back memories in those days more reliably.

(2-2-2. Internal Configuration Example of Smartphone)

Next, a configuration of the smartphone l′ according to the present embodiment will be described with reference to FIG. 10. FIG. 10 is a block diagram illustrating an internal configuration example of the smartphone l′ according to the second embodiment. As illustrated in FIG. 10, the smartphone l′ includes a control unit 10′, the communication unit 12, the display unit 13, the manipulation input unit 14, the speaker 15, the storage unit 16, a lifelog DB 17A, and a viewing/listening history DB 17B. Since the communication unit 12, the display unit 13, the manipulation input unit 14, the speaker 15, and the storage unit 16 have the same configurations as those in the first embodiment described with reference to FIG. 3, a description of the configuration is herein omitted.

The control unit 10′ issues instructions to the components of the smartphone l′ to control the entire smartphone V. Specifically, as illustrated in FIG. 10, the control unit 10′ functions as the first-content specifying unit 110, the period specifying unit 120, an extraction unit 130′, the reproduction control unit 140, a content specifying unit 150, a period estimation unit 160, and a metadata generation unit 170.

The content specifying unit 150 specifies first content on which popular period association processing (metadata generation processing) is to be performed. Specific processing performed by the content specifying unit 150 is the same as the processing performed by the content specifying unit 210 according to the first embodiment.

The period estimation unit 160 estimates a personal popular period (personalized popular period) of the content specified by the content specifying unit 150. Note that the personal popular period herein means a period in which an individual is interested and absorbed in content. In a case where the content is news, the personal popular period is also referred to as a personal attention period. The personal popular period is estimated based on, for example, a lifelog, a viewing/listening history, a purchase history, or the like of an individual. The period estimation unit 160 estimates a personal popular period or a personal attention period of a tune, video, a game, news, play, a toy, a vogue word, a commodity, a fashion, or the like.

Specifically, based on a viewing/listening history stored in the viewing/listening history DB 17B, the period estimation unit 160 may obtain, as an estimation result of the user's personal popular period of a tune, video, or a game, a period exhibiting, for example, the number of viewing/listening times which is equal to or larger than a predetermined number of times and is the largest. When the number of viewing/listening times is smaller than the predetermined value, the period estimation unit 160 may consider that the personal popular period does not exist and then terminate the metadata generation processing. Note that the period estimation unit 160 can also estimate a period in which a tune or video has been popular, based on recording times information indicating the number of times of audio or image recording performed by the user, or recording duration information indicating a recording duration taken for the audio or image recording.

The period estimation unit 160 may also estimate the user's personal attention period of a news item based on presence of viewing the news item or a viewing duration which is stored in the viewing/listening history DB 17B. When the news item has been viewed or when the viewing duration is longer than a predetermined time, the period estimation unit 160 may obtain a period including the viewing of the news item, as an estimation result of the user's personal attention period of the news item. Moreover, in the case where the history shows that the user is in favor of the news item (where a button for indicating favor is selected), the period estimation unit 160 may obtain a period in which the news item is viewed, as an estimation result of a personal attention period of the news item. Further, the period estimation unit 160 may estimate a period in which the news item is viewed, based on the user's biological information stored in the lifelog DB 17A. When the degree of user's concentration in viewing the news item is higher than a predetermined value in a certain period, the period estimation unit 160 may obtain the period in which the news item is viewed, as an estimation result of a personal attention period of the news item.

The period estimation unit 160 may also obtain, as an estimation result of the user's personal popular period of a certain type of play, a year when the type of play has appeared (been recorded) most frequently, based on a lifelog stored in the lifelog DB 17A (such as audio data, shot image data, or electronic diary data).

The period estimation unit 160 may also obtain, as an estimation result of the user's personal popular period of a certain toy, a period in which the user purchases the toy, based on the user's purchase history information.

The period estimation unit 160 may also obtain, as an estimation result of the user's personal popular period of a certain keyword, a year when the keyword has appeared most frequently, based on a lifelog stored in the lifelog DB 17A.

The period estimation unit 160 may also obtain, as an estimation result of the user's personal popular period of a certain commodity, a period in which the user has purchased the commodity, based on the user's purchase history information.

The period estimation unit 160 may also obtain, as an estimation result of the user's personal popular period of a certain fashion item, a period in which the user has purchased the fashion item, based on the user's purchase history information. The period estimation unit 160 may also obtain, as an estimation result of a personal popular period of a certain fashion item, a period in which the fashion item has appeared (been shot) most frequently, based on shot image data (photos and video) of the user. Note that the fashion item includes not only fashion accessories (such as glasses, a hat, shoes, a stole, a necklace, and earrings for pierced ears) but also clothing (such as a coat, a skirt, trousers, and a blouse).

The specific methods for estimating a popular period by the period estimation unit 160 has heretofore been described. Note that the period estimation unit 160 according to the present embodiment may weight the estimated popular period, based on the type of data used for the estimation (the lifelog, the viewing/listening history, or the like), data reliability, or the like.

The period estimation unit 160 may also estimate the user's personal popular period based on the number of viewing/listening times or a viewing duration which is weighted based on the user's biological information (such as a blood pressure, a heart rate, a perspiration amount, pulse waves, and brain waves). The biological information is detected through an HMD (Head Mount Display) or the like worn by the user when the user views and listens to content.

The metadata generation unit 170 performs processing in which the user's personal popular period estimated by the period estimation unit 160 is associated as metadata with the specified content (second content). At this time, the metadata generation unit 170 may associate, as metadata, not only the personal popular period but also the number of viewing/listening times or the like used as a basis of the estimation. The metadata generation unit 170 also stores the content associated with the personal popular period as the metadata in the storage unit 16.

Since the first-content specifying unit 110, the period specifying unit 120, and the reproduction control unit 140 have the same configurations as those in the first embodiment described with reference to FIG. 3, a description of the configuration is herein omitted.

Meanwhile, the extraction unit 130′ according to the present embodiment extracts second content in which the user has been personally interested in the period specified by the period specifying unit 120. The second content is extracted, for example, from the storage unit 16. As described above, the storage unit 16 in advance stores therein second content associated as metadata with a personal popular period by the metadata generation unit 170. The extraction unit 130′ according to the present embodiment extracts second content associated as the metadata with a personal popular period overlapping the period specified by the period specifying unit 120.

The lifelog DB 17A is a storage unit which stores lifelogs of the user. In the lifelogs, various actions of a person are recorded as electronic data. More specifically, the lifelogs may be, for example, daily biological information (such as a blood pressure, a heart rate, a perspiration amount, pulse waves, and brain waves) of the user, audio data of the user, image data as results of shooting the surrounding of the user, and an electronic diary data inputted by the user.

These lifelogs may be acquired from a camera (not shown), a microphone (not shown), the manipulation input unit 14, or the like which is provided to the smartphone 1′, or may be acquired from a wearable device worn by the user. The wearable device is a device including the camera, the microphone, a biological information detection unit, and the like, and may be a glass HMD, for example. The glass HMD is an HMD including a device capable of controlling transparency of a display unit placed just in front of the user when the user wears the HMD on the head or face. Controlling the display unit in a see-through state or a semi-see-through state enables the user to perform daily activities with the HMD worn like glasses at all times.

The viewing/listening history DB 17B is a storage unit which stores history information on content viewing/listening by the user. As the viewing/listening history information, for example, a viewing duration or the number of times of viewing a film, a photo image, a news article, or the like reproduced on the display unit 13 by the control unit 10′ may be calculated and stored in the viewing/listening history DB 17B. In addition, the number of times or a duration of reproducing music through the speaker 15 by the control unit 10′ may be calculated and stored in the viewing/listening history DB 17B as the viewing/listening history information. Further, history information on the user's viewing/listening content received from an external device by the communication unit 12 may be stored in the viewing/listening history DB 17B.

With the configuration described above, the smartphone l′ according to the present embodiment extracts second content based on a personalized popular period, and thus can extract content which can more reliably bring back memories in those days.

(2-2-3. Modification)

Next, a case where there are a plurality of users will be described as a modification of the second embodiment described above. Note that the present modification assumes that a popular period of each user is associated as metadata with corresponding one of second content pieces.

In the case where there are a plurality of users, the extraction unit 130′ of the smartphone l′ extracts second content pieces in which the users have been interested, respectively, in a period relevant to a first content piece. Specifically, for example, the extraction unit 130′ extracts: a second content piece a based on a popular period of a user a; and a second content piece b based on a popular period of a user b. Then, the reproduction control unit 140 performs control in a manner that the second content pieces extracted for the respective users, that is, the second content piece a and the second content piece b are reproduced alternately.

Alternatively, in the case where there are a plurality of users, the extraction unit 130′ of the smartphone l′ may extract a second content piece in which both the users have been interested in the period relevant to the first content. Specifically, for example, based on popular periods of the user a and the user b, respectively, the extraction unit 130′ extracts a second content piece c associated with a popular period of both the users which overlaps a period relevant to a first content piece. Then, the reproduction control unit 140 performs control in such a manner as to reproduce a second content piece, that is, the second content piece c in which both the users have been interested in common in the period relevant to the first content piece. As described above, the extraction unit 130′ according to the present embodiment can merge (normalize) popular periods of users into one to extract a second content piece.

### 3. Conclusion

As described above, according to the present embodiments, it is possible to provide content for recollecting particular times and bringing back memories by estimating a period (popular period) in which people in general or an individual is interested in the content and by generating metadata indicating the estimated period in association with the content.

Moreover, according to the present embodiments, second content which has been popular in a period relevant to first content (such as a shooting date or a release date) viewed/listened/selected by the user is extracted based on the period and is reproduced. This enables the user to recollect the period relevant to the first content viewed/listened/selected and to feel presence and longing.

Further, according to the present embodiments, it is possible to extract content which can bring back memories in those days more reliably by extracting second content based on a personalized popular period.

It should be understood by those skilled in the art that various modifications, combinations, sub-combinations and alterations may occur depending on design requirements and other factors insofar as they are within the scope of the appended claims or the equivalents thereof.

For example, it is also possible to generate a computer program for causing hardware such as a CPU (Central Processing Unit), a ROM (Read Only Memory), and a RAM (Random Access Memory) which are built in the smartphone 1 or 1′ or the data generation server 2 to exert the aforementioned functions of the smartphone 1 or 1′ or the data generation server 2. There is also provided a computer-readable storage medium having the computer program stored therein.

Still further, in the description of the embodiments, a popular period is associated as metadata with content data, and the metadata and the content data are together stored in the content DB 24 or the storage unit 16. However, the storage method according to the present embodiments is not limited thereto. For example, the content provision system according to an embodiment of the present disclosure may store the metadata including the popular period and the content data in respective different locations.

For example, in the content provision system according to any of the present embodiments, the storage unit 16 of the smartphone 1 may store metadata associated with a name, a storage location, or the like of content, and an external device may store the content therein. In this case, the extraction unit 130 of the smartphone 1 acquires the content (second content) from the external device as necessary.

Yet further, in the content provision system according to any of the present embodiments, the storage unit 16 of the smartphone 1 may store content, and the data generation server 2 may store metadata associated with a name, a storage location, or the like of the content. In this case, the extraction unit 130 of the smartphone 1 acquires the metadata from the data generation server 2 as necessary and extracts the content (second content) from the storage unit 16 based on the metadata.

Additionally, the present technology may also be configured as below.

(1) A data generation device including:

a content specifying unit configured to specify content;

a period estimation unit configured to estimate a period in which the content specified by the content specifying unit attracts interest; and

a metadata generation unit configured to associate as metadata the period estimated by the period estimation unit with the content.

(2) The data generation device according to (1),

wherein the period estimation unit estimates the period based on information indicating interest of people in general or an individual.

(3) The data generation device according to (2),

wherein the information indicating interest of people in general or an individual is at least one of ranking information, information on a number of reproduction times, information on a number of recording times, reproduction duration information, recording duration information, broadcasting duration information, information on a number of viewing times, information on a number of magazine placement times, news information, lifelog information, viewing/listening history information, and purchase record information.

(4) The data generation device according to (1),

wherein the period estimation unit estimates a period in which people in general are interested in the content based on predetermined ranking information.

(5) The data generation device according to (1),

wherein the period estimation unit estimates a period in which a particular user is interested in the content based on at least one of a content viewing/listening history, a content recording history, a lifelog, and a purchase history of the user.

(6) The data generation device according to any one of (1) to (5),

wherein when another period in which the content attracts interest is estimated, the metadata generation unit associates the period as a second interest period with the content.

(7) A content reproduction device including:

a content specifying unit configured to specify a piece of first content;

a period specifying unit configured to specify a period relevant to the piece of first content;

a content extraction unit configured to extract, among pieces of second content associated with periods in which the respective pieces of second content attract interest, a piece of second content associated with a period overlapping with the period specified by the period specifying unit; and

a content reproduction unit configured to reproduce the piece of second content extracted by the content extraction unit.

(8) The content reproduction device according to (7),

wherein the content reproduction unit reproduces the piece of first content and the piece of second content.

(9) The content reproduction device according to (7) or (8),

wherein the period specifying unit specifies a period in which the piece of first content is acquired, released, or held, as the period relevant to the piece of first content.

(10) The content reproduction device according to any one of (7) to (9),

wherein each of the pieces of second content is associated as metadata with a period in which people in general are interested in the piece of second content, based on at least one of predetermined ranking information, information on a number of recording times, information on a number of reproduction times, reproduction duration information, recording duration information, information on a number of viewing times, information on a number of magazine placement times, and news information.

(11) The content reproduction device according to any one of (7) to (9),

wherein each of the pieces of second content is associated as metadata with a period in which a particular user is interested in the piece of second content, based on at least one of a content viewing/listening history, a content recording history, a lifelog, and a purchase history of the user.

(12) A non-transitory computer-readable storage medium having a program stored therein, the program causing a computer to function as:

a content specifying unit configured to specify content;

a period estimation unit configured to estimate a period in which the content specified by the content specifying unit attracts interest; and

a metadata generation unit configured to associate as metadata the period estimated by the period estimation unit with the content.

(13) A non-transitory computer-readable storage medium having a program stored therein, the program causing a computer to function as:

a content specifying unit configured to specify a piece of first content;

a period specifying unit configured to specify a period relevant to the piece of first content;

a content extraction unit configured to extract, among pieces of second content associated with periods in which the respective pieces of second content attract interest, a piece of second content associated with a period overlapping with the period specified by the period specifying unit; and

a content reproduction unit configured to reproduce the piece of second content extracted by the content extraction unit.

What is claimed is:

1. A data generation device comprising:
a content specifying unit configured to specify content;
a period estimation unit configured to estimate a period in which the content specified by the content specifying unit attracts interest; and
a metadata generation unit configured to associate as metadata the period estimated by the period estimation unit with the content.

2. The data generation device according to claim 1,
wherein the period estimation unit estimates the period based on information indicating interest of people in general or an individual.

3. The data generation device according to claim 2,
wherein the information indicating interest of people in general or an individual is at least one of ranking information, information on a number of reproduction times, information on a number of recording times, reproduction duration information, recording duration information, broadcasting duration information, information on a number of viewing times, information on a number of magazine placement times, news information, lifelog information, viewing/listening history information, and purchase record information.

4. The data generation device according to claim 1,
wherein the period estimation unit estimates a period in which people in general are interested in the content based on predetermined ranking information.

5. The data generation device according to claim 1,
wherein the period estimation unit estimates a period in which a particular user is interested in the content based on at least one of a content viewing/listening history, a content recording history, a lifelog, and a purchase history of the user.

6. The data generation device according to claim 1,
wherein when another period in which the content attracts interest is estimated, the metadata generation unit associates the period as a second interest period with the content.

7. A content reproduction device comprising:
a content specifying unit configured to specify a piece of first content;
a period specifying unit configured to specify a period relevant to the piece of first content;
a content extraction unit configured to extract, among pieces of second content associated with periods in which the respective pieces of second content attract interest, a piece of second content associated with a period overlapping with the period specified by the period specifying unit; and
a content reproduction unit configured to reproduce the piece of second content extracted by the content extraction unit.

8. The content reproduction device according to claim 7,
wherein the content reproduction unit reproduces the piece of first content and the piece of second content.

9. The content reproduction device according to claim 7,
wherein the period specifying unit specifies a period in which the piece of first content is acquired, released, or held, as the period relevant to the piece of first content.

10. The content reproduction device according to claim 7,
wherein each of the pieces of second content is associated as metadata with a period in which people in general are interested in the piece of second content, based on at least one of predetermined ranking information, information on a number of recording times, information on a number of reproduction times, reproduction duration information, recording duration information, information on a number of viewing times, information on a number of magazine placement times, and news information.

11. The content reproduction device according to claim 7,
wherein each of the pieces of second content is associated as metadata with a period in which a particular user is interested in the piece of second content, based on at least one of a content viewing/listening history, a content recording history, a lifelog, and a purchase history of the user.

12. A non-transitory computer-readable storage medium having a program stored therein, the program causing a computer to function as:
a content specifying unit configured to specify content;
a period estimation unit configured to estimate a period in which the content specified by the content specifying unit attracts interest; and
a metadata generation unit configured to associate as metadata the period estimated by the period estimation unit with the content.

13. A non-transitory computer-readable storage medium having a program stored therein, the program causing a computer to function as:
a content specifying unit configured to specify a piece of first content;
a period specifying unit configured to specify a period relevant to the piece of first content;
a content extraction unit configured to extract, among pieces of second content associated with periods in which the respective pieces of second content attract interest, a piece of second content associated with a period overlapping with the period specified by the period specifying unit; and
a content reproduction unit configured to reproduce the piece of second content extracted by the content extraction unit.
